(19) United States
(12) Patent Application Publication
(10) Pub. No.: US 2026/0161002 A1
(43) Pub. Date: Jun. 11, 2026

(54) DETECTING BREAKAGE OF DISPLAY WAVEGUIDES

(71) Applicant: GOOGLE LLC, Mountain View, CA (US)

(72) Inventors: Shreyas Potnis, Kitchener (CA); Andrew Logan, Waterloo (CA); Ali Karbasi, Los Gatos, CA (US); Timothy Paul Bodiya, Toronto (CA); Joshua Moore, Elora (CA)

(21) Appl. No.: 18/706,731

(22) PCT Filed: Sep. 21, 2022
(86) PCT No.: PCT/US2022/044192

§ 371 Date: May 1, 2024

Related U.S. Application Data
(60) Provisional application No. 63/276,044, filed on Nov. 5, 2021.

(51) Int. Cl. G02B 27/01; G01M 11/08

(52) U.S. Cl. CPC G02B 27/0176; G01M 11/08; G02B 2027/0167; G02B 2027/0178

(57) ABSTRACT

A head mounted display (HMD) device includes a frame housing a micro-display or other image projector to project display light and a display waveguide to receive the display light from the image projector. A detection controller determines a breakage status of the display waveguide. The breakage status may be determined based on monitored sensors housed within the frame. For example, a monitored sensor may include an electrically conductive loop positioned around a perimeter of at least a portion of the display waveguide, with one or more electrical contact pads in electrical contact with the electrically conductive loop and communicatively connected to the detection controller to determine the breakage status based on monitored loop resistance of the electrically conductive loop.

### BACKGROUND

In the field of optics, a combiner is an optical apparatus that combines two light sources, for example, light transmitted from a micro-display and directed to the combiner via a display waveguide, and environmental light from outside of the combiner. Optical combiners are used in heads up displays (HUDs), sometimes referred to as head mounted displays (HMDs) or near-eye displays, which allow a user to view computer-generated content (e.g., text, images, or video content) superimposed over a user's environment viewed through the HMD, creating what is commonly known as augmented reality (AR). In some applications, an HMD is implemented in an eyeglass frame form factor with the optical combiner forming at least a portion of one of the lenses within the eyeglass frame. The HMD enables a user to view the computer-generated content substantially simultaneously with the environmental view.

A display waveguide in AR glasses may be formed using a thin substrate of a transparent material (e.g., glass, plastic) with diffractive, reflective, or holographic couplers to guide the display light from the source where it is generated into a user's eyebox region.

Thus, the display waveguide may comprise a thin piece of transparent material embedded within a lens of the AR glasses. Such a device can have high intensity light guided within the display waveguide. For example, the high intensity light may be generated in an arm of the glasses and may be projected into the display waveguide, propagating within the display waveguide via internal reflection, to then be sent out to the user's eye.

As a conventional waveguide typically is relatively thin (e.g., often 0.5 mm or less), it is prone to cracking or other breakage, which can affect performance by, for example, rendering the waveguide completely non-functional in the case of a complete break, or by introducing significant image distortions and ghost images in the case of fractures in the display waveguide. Further, cracks or other breakages in a waveguide have the potential to create unintended paths for high intensity light to leak out, which may pose a safety risk for users or bystanders.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a display system that detects breakage of a display waveguide, in accordance with some embodiments.

FIG. 2 illustrates a lateral cross-section of the display system of FIG. 1, in accordance with some embodiments.

FIG. 3 illustrates a top view of a display waveguide with a conductive loop, in accordance with some embodiments.

FIG. 4 illustrates an eye-facing view of the display waveguide with the conductive loop of FIG. 3, in accordance with some embodiments.

FIG. 5 illustrates an eye-facing view of a display waveguide with a conductive loop, within a frame of the display system of FIGS. 1-2, in accordance with some embodiments.

FIG. 6 illustrates a top view of a display waveguide with a strain gauge and monitor, in accordance with some embodiments.

FIG. 7 illustrates a top view of a display waveguide with a light source and one or more photodiodes, in accordance with some embodiments.

FIG. 8 illustrates a top view of a display waveguide with a surface acoustic wave (SAW) generator and a SAW detector, in accordance with some embodiments.

FIG. 9 is a flow chart illustrating a method of making a conductive loop for detecting display waveguide breakage in accordance with some embodiments.

FIG. 10 is a flow chart illustrating a method of detecting display waveguide breakage in accordance with some embodiments.

### DETAILED DESCRIPTION

The description herein is generally directed to various systems and techniques for detecting breakage of display waveguides in augmented reality systems. The description is further directed to systems and techniques for mitigating potential adverse effects resulting from the breakage of the display waveguides. In some implementations, a detection controller housed in a frame of AR glasses may determine a breakage status indicating the breakage of a display waveguide based on monitoring one or more sensors housed within the frame. The detection controller can initiate a deactivation of a micro-display or other projector in response to determining the breakage of the display waveguide. In some embodiments, display waveguide breakage detection may include applying an electrically conductive loop around a perimeter of a display waveguide with electrical contact pads operably connected to a circuit that monitors loop resistance (e.g., short circuit vs open circuit). In some embodiments, in addition to detecting breakage, the electrically conductive loop may advantageously act as a wireless antenna, such as a wireless personal area network (WPAN) antenna or wireless local area network (WLAN) antenna, potentially dispensing with a need for additional physical antenna elements in the system. This display waveguide breakage detection further can include adding strain gauges on points of contact of the display waveguide with the mounting frame to detect change in stress in the assembly due to breakage. This display waveguide breakage detection process also can include providing photodiodes that monitor incoupled light as it reaches an edge of the display waveguide and detect changes to the incoupled light. In some embodiments, display waveguide breakage detection includes coupling surface acoustic waves (SAWs) on the display waveguide and providing a detector that detects changes to the amplitude of the SAWs.

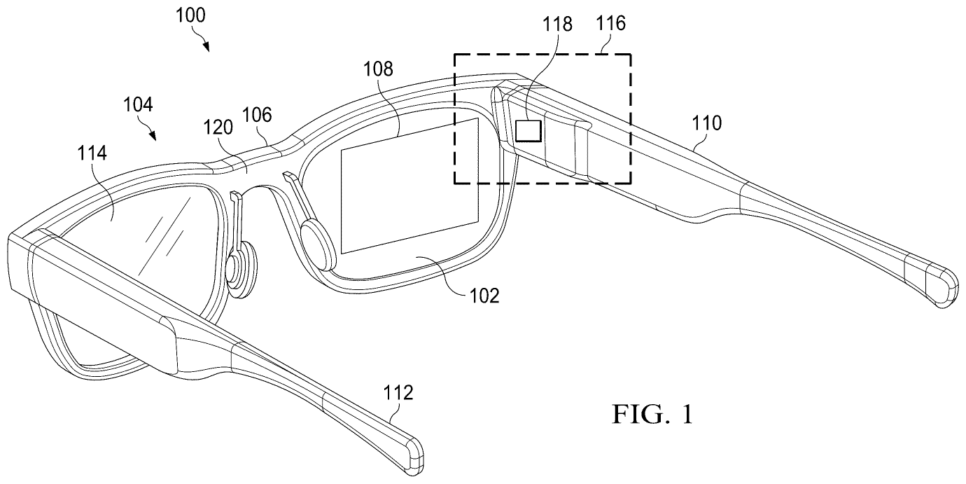

FIG. 1 illustrates an example display system 100 that implements one or more display waveguide detection techniques, in accordance with some embodiments. The display system 100 employs an optical combiner 102 having a support structure 104 that includes a frame 106, which houses a micro-display, scanning mirror laser projector, or other projector (not shown in FIG. 1) that is configured to project images toward the eye of a user, such that the user perceives the projected images as being displayed in a field of view (FOV) area 108 at the combiner 102. The support structure 104 also includes components to allow the support structure 104 to be worn in a position in front of a user's eyes. Examples of such components are arms 110 and 112 (also known as “temples”) to be supported by a user's ears. A strap, or straps (not shown), configured to be worn around and/or on top of a user's head may be used in place of one or more of the arms in some embodiments to secure the support structure 104 in front of a user's eyes. In some embodiments, the display system 100 is symmetrically configured such that a lens element 114 is also a combiner and a micro-display is housed in the portion of the frame 106 proximate to the arm 112 to project images to a FOV area within the lens element 114. In some embodiments, the micro-display may be housed in a nose bridge portion 120 of the frame 106 to project images to the FOV area within the lens element 114.

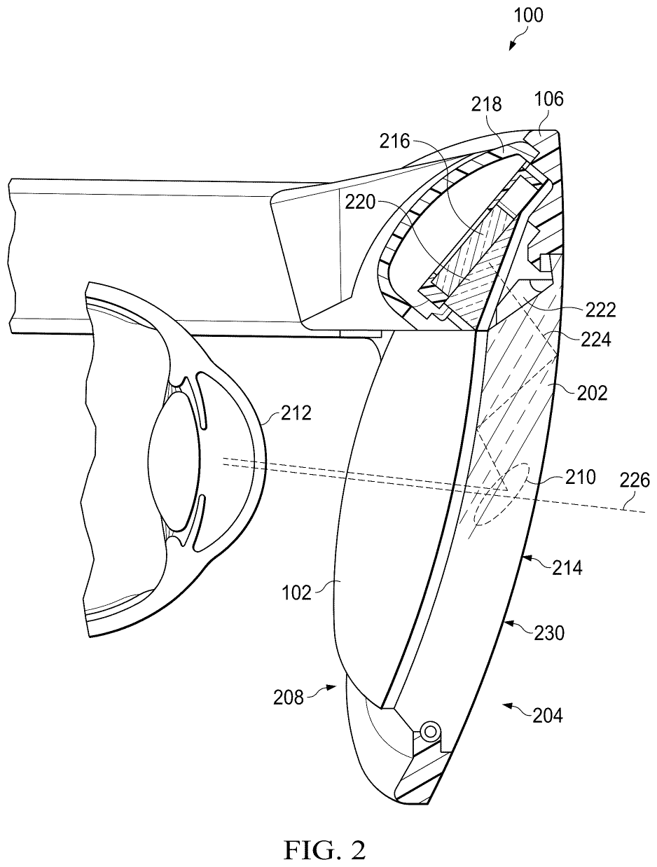

In the depicted example, the display system 100 is a near-eye display system in the form of an HMD in which the support structure 104 is configured to be worn on the head of a user and has a general shape and appearance (or “form factor”) of an eyeglasses frame. The support structure 104 contains or otherwise includes various components to facilitate the projection of such images toward the eye of the user, such as a micro-display and field lens, which are described in greater detail below with reference to FIG. 2. In some embodiments, the support structure 104 further includes various sensors, such as one or more front-facing cameras, rear-facing cameras, other light sensors, motion sensors, accelerometers, and the like. The support structure 104 further can include one or more radio frequency (RF) interfaces or other wireless interfaces, such as a Bluetooth (TM) interface, a wireless fidelity (WI-FI) interface, and the like. Further, in some embodiments, the support structure 104 further includes one or more batteries or other portable power sources for supplying power to the electrical and processing components, such as one or more processors of a processing system, of the display system 100. In some embodiments, some or all of these components of the display system 100 are fully or partially contained within an inner volume of the support structure 104, such as within the arm 110 and the portion of the frame 106 in region 116 of the support structure 104. In some embodiments, some or all of these components of the display system 100 are fully or partially contained within the nose bridge portion 120 of the frame 106. It should be noted that while an example form factor is depicted, it will be appreciated that in other embodiments the display system 100 may have a different shape and appearance from the eyeglasses frame depicted in FIG. 1.

In the depicted embodiment, the combiner 102 is used by the display system 100 to provide an augmented reality (AR) display in which rendered graphical content can be superimposed over or otherwise provided in conjunction with a real-world view as perceived by the user through the combiner 102. For example, light used to form a perceptible image or series of images may be projected by a micro-display of the display system 100 onto the eye of the user via a series of optical elements, such as a display waveguide formed at least partially in combiner 102 and one or more lenses and/or filters disposed between the micro-display and the display waveguide, as is described further below. The optical combiner 102 includes at least a portion of a display waveguide that routes display light received by an incoupler of the display waveguide to an outcoupler of the display waveguide, which outputs the display light toward an eye of a user of the display system 100. In addition, the optical combiner 102 is sufficiently transparent to allow a user to see through combiner 102 to provide a field of view of the user's real-world environment such that the image appears superimposed over at least a portion of the real-world environment. For example, the processing components discussed above may include a detection controller 118 that determines a current breakage status of the display waveguide based on monitoring one or more sensors housed within the frame. For example, the detection controller may include any type of single or distributed circuits or processors (e.g., one or more application-specific integrated circuits (ASICs), central processing units (CPUs), etc.) For example, the current breakage status may indicate that the display waveguide is intact, damaged, has fissures, or has some other discontinuity that may adversely affect light traveling through the display waveguide. In some embodiments, the detection controller 118 initiates a deactivation of a micro-display or other projector in response to determining a breakage, fissure, or some other discontinuity of the display waveguide.

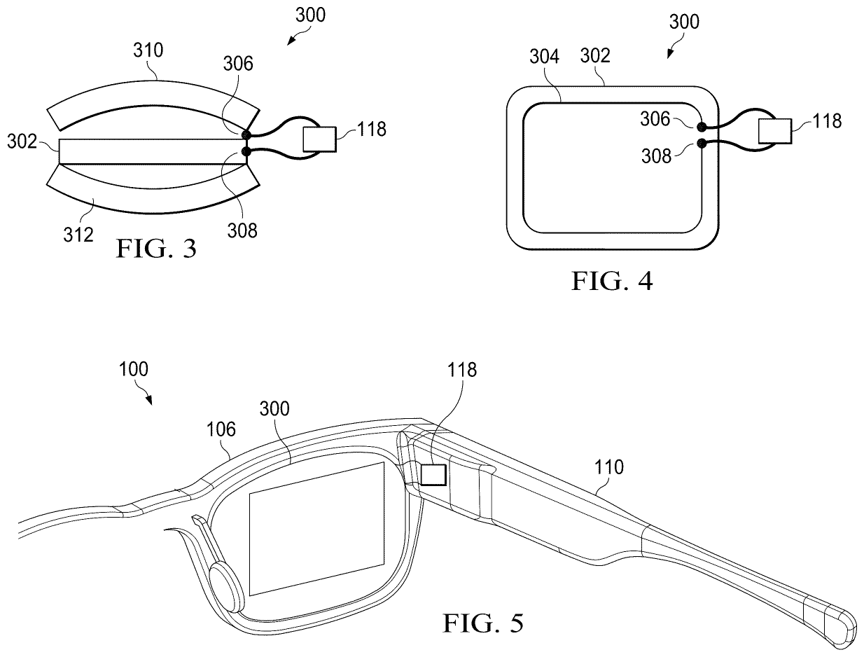

Although not depicted in FIG. 1 but described in detail below with reference to FIGS. 3-5, in some embodiments an electrically conductive loop is positioned around a perimeter of at least a portion of the display waveguide with electrical contact pads communicatively connected to the detection controller 118. For this example, the detection controller 118 initiates provision of an electrical current to the electrically conductive loop and monitors loop resistance (i.e., short circuit vs open circuit), based on a predetermined threshold of resistance. In some embodiments, the detection controller 118 determines the breakage or other discontinuity of the display waveguide based on the monitored loop resistance. In some embodiments, the loop may serve as an interlock and it may be desirable to identify whether a user has tampered with the device and shorted out the leads to the controller (e.g., to make it seem as though the display waveguide is present and intact). In that case the electrically conductive loop may be implemented to have a specific impedance (e.g., an impedance within a predefined threshold range), and the detection controller 118 may determine the breakage or other discontinuity of the display waveguide based on identifying changes to the impedance of the electrically conductive loop.

In some embodiments, in addition to its use in detecting breakage, the conductive loop may advantageously perform a function of a radio frequency antenna, potentially dispensing with a need for additional physical elements in the system. For example, the radio frequency antenna may include a Bluetooth™ or WI-FI antenna.

In some embodiments, the detection controller 118 may be located in the region 116 of the support structure 104, as shown in FIG. 1. In some embodiments, the electrically conductive loop (see, e.g., conductive loop 214, FIG. 2) is placed at or substantially near to an edge of a lens that embodies the display waveguide, as glass breakage may initially occur at the edge of the glass piece and propagate to the center of the glass piece, and thus, detection of glass breakage may indicate breakage of the display waveguide. For example, the electrically conductive loop may comprise an electrically conductive metallic material (e.g., aluminum, silver, chromium, gold, etc.). In some embodiments, the conductive loop is a few microns in thickness (e.g., 5-50 microns in thickness), the loop extending around the whole of the glass (or plastic) piece housing the display waveguide. In some embodiments, the electrically conductive loop may be disposed around only specific portions of the display waveguide that may be of interest. For example, if there is interest in monitoring an exit pupil expander (EPE) area, the electrically conductive loop may be disposed around the EPE. Such focused monitoring may advantageously result in a smaller conductive loop, or a conductive loop that may be commonly used for many different lens shapes. In some embodiments, the conductive loop is substantially clear, so that the conductive loop is not visible, and the lens housing the conductive loop appears transparent from a perspective of a user.

In some embodiments, the detection controller 118 determines that a breakage of the display waveguide has occurred based on determining that the conductive loop is currently not a short circuit, based on the monitored loop resistance. In some embodiments, the detection controller 118 may initiate a deactivation (e.g., a switching off) of a projector (e.g., a micro-display) of the display system 100, to mitigate potential adverse effects resulting from the breakage of the display waveguide.

FIG. 2 illustrates a lateral cross-section of the system 100 including the combiner 102 mounted within the frame 106 in accordance with at least one embodiment. The combiner 102 includes a display waveguide 202 located at the world-side 204 of the combiner 102, opposite the eye-side 208 of the combiner 102. The display waveguide 202 is configured to act upon light traveling within the display waveguide 202 to change at least one of the direction that the light is traveling, the polarization state of the light, and the angle at which light is refracted or reflected. These changes facilitate conveyance of light within the display waveguide 202 to an outcoupler feature 210, where the light is then directed out of the display waveguide 202 towards a user's eye 212.

The display waveguide 202 is positioned within the frame 106 to receive display light from a micro-display 216 mounted within a housing 218 at the top of the frame 106. The micro-display 216 is connected to computing components (not shown) responsible for providing computer-generated content to the micro-display 216. Note that in other implementations, a different form of image projector may be used, such as a MEMS-based laser-scanning projector, and thus reference to micro-display 216 applies equally to other types of image projectors unless otherwise indicated. In some embodiments, computer-generated content includes video content, images, or text that is intended to be viewed by a user wearing the display system 100. In some embodiments, light emitted from the micro-display 216 is conveyed through a field lens 220, which acts to align the light in a parallel fashion so that the light has minimal spread as it propagates within the display waveguide 202. After traveling through the field lens 220 to correct field aberrations, such as distortion, the light is transmitted into the display waveguide 202 at an incoupler feature 222 as display light 224.

In some embodiments, the micro-display 216 is a transmissive display, such as a light-emitting diode (LED) or organic light-emitting diode (OLED) display. In some embodiments, the micro-display 216 is a reflective display, such as a scanning laser projector or a combination of a modulative light source and a dynamic reflector mechanism or digital light processor. The micro-display 216 projects light over a variable area, designated the FOV area 108 (shown in FIG. 1), of the display system 100. The projected area size corresponds to the size of the FOV area 108 and the projected area location corresponds to a region of the optical combiner 102 in which the FOV area 108 is visible to the user.

Generally, it may be desirable for a display to have a wide FOV to accommodate the outcoupling of light across a wide range of angles. Herein, the range of different user eye positions that will be able to see the display is referred to as the eyebox of the display.

The display waveguide 202 is formed from a transparent optical material, which allows environmental light 226 to be transmitted through the combiner 102 such that the environmental light 226 is combined with display light 224 conveyed from the display waveguide 202 to present the user with an image overlaying the user's environment. As discussed above with regard to FIG. 1, the detection controller 118, in some embodiments, may be implemented at least in part using a conductive loop, such as the illustrated conductive loop 214 formed from a conductive material, positioned around a perimeter of the display waveguide 202 with electrical contact pads communicatively connected to a circuit that monitors loop resistance (i.e., short circuit vs open circuit).

In order to present an image for viewing by a user, the micro-display 216 directs light to the field lens 220, which directs the light onto the incoupler feature 222. The incoupler feature 222 directs the light into the display waveguide 202 of the combiner 102 as display light 224, which is then conveyed within and along the display waveguide 202 via total internal reflection (TIR) to the outcoupler feature 210 of the combiner 102. The outcoupler feature 210 is configured to reflect the display light 224 at an angle less than the critical angle so that the display light 224 is directed out of the combiner 102 toward the user's eye 212. The combination of display light 224 reflected from the outcoupler feature 210 and environmental light 226 transmitted through the combiner 102 from the world-side 204 create an AR scene viewable by the user. As the display light 224 representing an image and the environmental light 226 both travel toward the user's eye 212, the user will see both the image and the environmental scene in focus. In general, the terms “incoupler feature” and “outcoupler feature” will be understood to refer to any type of optical structure, including, but not limited to, diffraction gratings, holograms, holographic optical elements (e.g., optical elements using one or more holograms), volume diffraction gratings, volume holograms, surface relief diffraction gratings, Fresnel reflectors, buried mirrors, Fresnel reflections, or surface relief holograms. In some embodiments, a given incoupler or outcoupler is configured as a transmissive grating (e.g., a transmissive diffraction grating or a transmissive holographic grating) that causes the incoupler or outcoupler to transmit light and to apply designed optical function(s) to the light during the transmission. In some embodiments, a given incoupler or outcoupler is a reflective grating (e.g., a reflective diffraction grating or a reflective holographic grating) that causes the incoupler or outcoupler to reflect light and to apply designed optical function(s) to the light during the reflection.

FIGS. 3-5 illustrate different views of an example conductive loop assemblage 300 of a display waveguide 302 with a conductive loop 304, in some embodiments. FIG. 3 illustrates a generalized top view of the example conductive loop assemblage 300 of the display waveguide 302. As shown more explicitly in FIG. 4, the conductive loop 304 is positioned to substantially surround the display waveguide 302, located at a perimeter of a lens embodying the display waveguide 302, in some embodiments. In some embodiments, the conductive loop 304 is positioned at an eye-facing surface of the display waveguide 302. In some embodiments, the conductive loop 304 is positioned at a world-side surface of the display waveguide 302. Electrical contact pads 306 and 308 are provided to communicatively couple the conductive loop 304 to a circuit (e.g., the detection controller 118). For illustration purposes, the conductive loop 304 is shown communicatively coupled to the detection controller 118 via electrical wires positioned between the respective electrical contact pads 306 and 308, and the detection controller 118, in some embodiments. In some embodiments, the conductive loop 304 may be coupled to the detection controller 118 via one or more circuits (e.g., an application-specific integrated circuit (ASIC), a central processing unit (CPU), etc.), or via wireless connection. In FIG. 3, the display waveguide 302 is shown as part of a plurality of lenses forming a lens stack that further includes lenses 310 and 312.

FIG. 4 illustrates an eye-facing view of the conductive loop assemblage 300 of the display waveguide 302 of FIG. 3, in some embodiments. As shown in FIG. 4, the conductive loop 304 is positioned to substantially surround the display waveguide 302, located at a perimeter of the lens embodying the display waveguide 302. In some embodiments, the conductive loop 304 may be buried, as part of a multi-element stack. The electrical contact pads 306 and 308 are provided to communicatively couple the conductive loop 304 to the detection controller 118. FIG. 5 illustrates an example positioning of the conductive loop assemblage 300 of FIGS. 3-4, shown in an eye-facing view within the frame 106 of the display system 100.

In the display system 100, the entire lens assembly (including the lens stack) is under stress when assembled. When the display waveguide 302 breaks, the stress is released. Thus, in some embodiments, strain gauges are placed on one or more points of contact of a display waveguide assembly with the frame 106 to detect change in stress in the assembly due to breakage of the display waveguide 302.

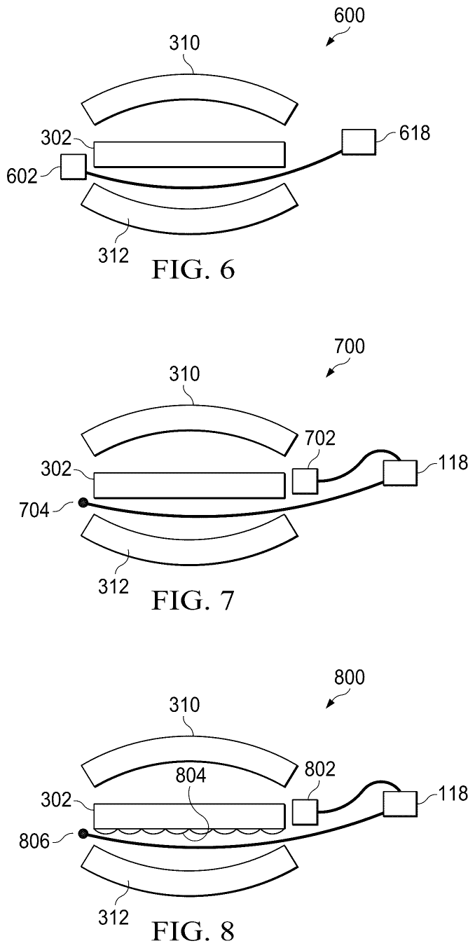

FIG. 6 illustrates a generalized top view of a strain gauge assemblage 600 that includes a strain gauge and monitor 602, communicatively connected to a strain detector 618 (one embodiment of the detection controller 118). As discussed above, the entire lens stack (e.g., display waveguide 302 and lenses 310 and 312) is under stress when assembled.

When the display waveguide 302 breaks, the stress is released, changing a signal of the strain gauge to the monitor. A breakage is determined by the strain detector 618 when a difference in the signal of the strain gauge is determined to exceed a predetermined strain threshold. In some embodiments, the strain gauge assemblage 600 is positioned within the frame 106 of the display system 100 similarly to the positioning of the conductive loop assemblage 300 as illustrated in FIG. 5, discussed above.

In some embodiments, one or more photodiodes may be provided that monitor incoupled light as the incoupled light reaches an edge of the display waveguide 302, the photodiodes detecting changes to the incoupled light. FIG. 7 illustrates a generalized top view of a photodiode assemblage 700 that includes a light source 702 positioned at an edge of the display waveguide 302, a photodiode 704 positioned at another edge of the display waveguide 302, opposite the light source 702, and the detection controller 118 that is communicatively connected to the photodiode 704. The light source 702 provides light (e.g., infrared light) that is directed via incoupled light into the display waveguide 302. In some embodiments, the micro-display 216 serves as the light source 702. The photodiode 704 detects light at an edge of the display waveguide 302, positioned opposite the light source 702. A breakage, fissure, or other anomaly of the display waveguide 302 causes a difference in the incoupled light that is received by the photodiode 704. A breakage is determined by the detection controller 118 when a difference in the signal of the photodiode 704 is determined to exceed a predetermined incoupled light threshold. In some embodiments, the photodiode assemblage 700 is positioned within the frame 106 of the display system 100 similarly to the positioning of the conductive loop assemblage 300 as illustrated in FIG. 5, discussed above.

Breaks, fissures, and other discontinuities in the display waveguide 302 impede the propagation of surface acoustic waves (SAWs). Accordingly, in at least one embodiment, the display system 100 implements breakage detection in the form of a SAW generator and SAW detector. FIG. 8 illustrates a generalized top view of an SAW assemblage 800 that includes a SAW generator 802, a SAW 804, and a SAW detector 806 communicatively connected to the detection controller 118, in some embodiments. For example, the SAW generator 802 may include a lead zirconium titanate (PZT) transducer and the SAW detector 806 may include a PZT detector, mounted at opposite sides of a lens employing the display waveguide 302, such as at lateral edges of the display waveguide 302 or top and bottom edges of the display waveguide 302. In the example shown in FIG. 8, the SAW detector 806 is communicatively connected to the detection controller 118. However, in some embodiments (not shown), the SAW detector may include a processor acting as a detection controller. In some embodiments, the SAW generator 802 includes a speaker, piezoelectric generator, or other vibrating component that operates to emit acoustic waves that are transmitted across the surface of the display waveguide 302 and detected by the SAW detector 806. In at least one embodiment, such acoustic waves are generated at one or more frequencies above human hearing range so as to be undetectable by the user. The detection controller 118 (or the SAW detector 706, in some embodiments) then compares the amplitude(s) of the actual received SAWs with an expected amplitude(s) of the SAWs to determine whether the display waveguide 302 has one or more breaks. For example, if the actual and expected amplitudes are within a specified threshold of each other, the detection controller 118 (or the SAW detector 806) determines that the display waveguide 302 is intact (i.e., determining a breakage status indicating that the display waveguide is not damaged), whereas if the magnitude of the amplitude difference between actual and expected amplitude exceeds the specified threshold, the detection controller 118 (or the SAW detector 806) determines that there is a break or other discontinuity in the display waveguide 302. In some embodiments, the SAW assemblage 800 is positioned within the frame 106 of the display system 100 similarly to the positioning of the conductive loop assemblage 300 as illustrated in FIG. 5, discussed above.

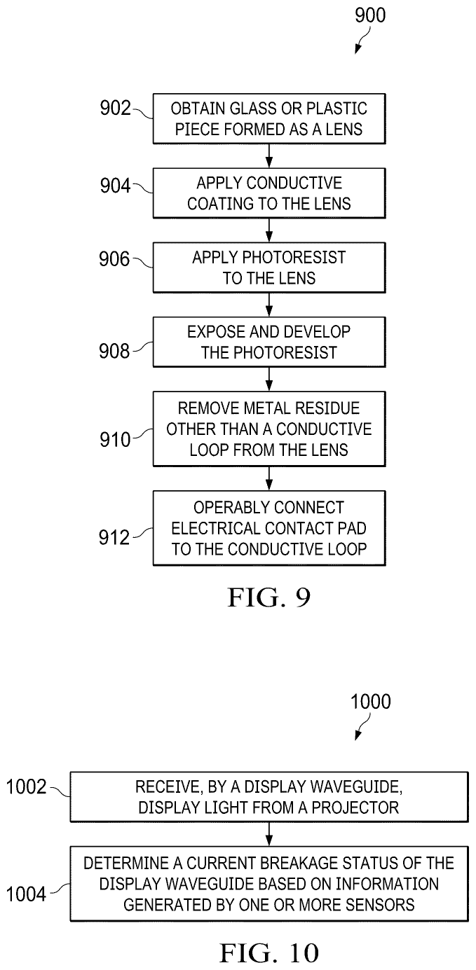

FIG. 9 is a flow chart illustrating a method of generating a conductive loop for detecting display waveguide breakage in accordance with some embodiments. At block 902, a glass or plastic piece formed as a lens is obtained. For example, the lens may embody a display waveguide (e.g., the display waveguide 302 of FIGS. 3-4).

At block 904, a conductive coating is applied on the glass or plastic. For example, the conductive coating may be applied on the surface of the lens or around the perimeter of at least a portion of the lens. In some embodiments, the conductive coating may be applied around the perimeter, to form an electrically conductive loop substantially around the perimeter (e.g., the conductive loop 304 of FIG. 4). In some embodiments, the electrically conductive loop may be disposed around only specific portions of the display waveguide that may be of interest. For example, if a user is interested in monitoring an exit pupil expander (EPE) area, the electrically conductive loop may be disposed substantially around the EPE. Such a conductive loop positioned around only a portion of the display waveguide may advantageously result in a smaller conductive loop, or a conductive loop that may be commonly used for many different lens shapes. In some embodiments, the conductive loop is substantially clear, so that the conductive loop is not visible, and the lens housing the conductive loop appears transparent from a perspective of a user.

For example, a thin film of metal may be deposited on the glass or plastic, around a perimeter of at least a portion of the lens, to form the conductive loop around the perimeter of at least a portion of the lens. For example, the deposited metal may comprise a conductive metallic material (e.g., aluminum, silver, chromium, gold, etc.) or alloy or other combination of such conductive materials. In some embodiments, the conductive loop is a few microns in thickness (e.g., approximately 5-50 microns in thickness), the loop extending around the whole of the glass (or plastic) piece. In some embodiments, the conductive loop is substantially clear, so that the conductive loop is not visible, and the lens appears transparent from a perspective of a user. At block 906, a photoresist is applied to the lens.

At block 908, the photoresist is exposed and developed. At block 910, metal residue, other than the conductive loop, is removed from the lens. At block 912, an electrical contact pad is operably connected to the conductive loop. In some embodiments, the electrical contact pad is communicatively connected to a circuit that monitors loop resistance. In some embodiments, the electrical contact pad may include the contact pad 306 or 308 of FIGS. 3-5. In some embodiments, the circuit includes the detection controller 118. In some embodiments, a display waveguide is embodied in the lens. For example, the display waveguide 202 is embodied in the lens.

In some embodiments, a conventional semiconductor fabrication process may be utilized to manufacture the conductive loop. In some embodiments, a three-dimensional (3D) printer may print the conductive metallic material on an edge of the lens, around the perimeter of the lens. In some embodiments, a conductive ink may be applied to a lens, or an epoxy embodying metallic particles capable of being monitored for resistance may be applied.

FIG. 10 is a flow chart illustrating a method of detecting display waveguide breakage in accordance with some embodiments. At block 1002, a display waveguide receives display light from a projector. For example, the display waveguide 202 of FIG. 2 may receive light from the micro-display 216. At block 1002, a current breakage status of the display waveguide is determined based on information generated by one or more sensors.

In some embodiments, the sensors include one or more electrical contact pads (e.g., the electrical contact pads 306, 308) in contact with a conductive loop (e.g., the conductive loop 304) positioned at a perimeter of at least a portion of the display waveguide 302, the electrical contact pads communicatively connected to a circuit (e.g., the detection controller 118) that monitors loop resistance of the conductive loop. For example, determining the current breakage status may include determining the current breakage status of the display waveguide based on the monitored loop resistance of the conductive loop. In some embodiments, the current breakage status is determined based on determining that the monitored loop resistance indicates that the conductive loop is currently not a short circuit. In some embodiments, the conductive loop is configured to perform a function of a radio frequency antenna. In some embodiments, a deactivation of the projector is initiated in response to determining a breakage status of the display waveguide indicating that the display waveguide is damaged.

In some embodiments, the sensors include one or more strain gauges (e.g., the strain gauge and monitor 602) disposed on one or more points of contact of an assembly of the display waveguide with a frame of a headset. For example, the current breakage status may be determined by detecting a change in stress in the assembly based on receiving strain gauge signals from the one or more strain gauges.

In some embodiments, the sensors include one or more photodiodes (e.g., the photodiode 704) that monitor incoupled light at an edge of the display waveguide. For example, the current breakage status may be determined by detecting one or more changes to the incoupled light.

In some embodiments, the sensors include one or more detectors (e.g., the SAW detector 806) that monitor surface acoustic waves (SAWs) (e.g., the SAW 804) coupled on the display waveguide. For example, the current breakage status may be determined by detecting changes to amplitude of one or more of the surface acoustic waves SAWs coupled on the display waveguide.

For example, the current breakage status of the display waveguide may include one or more of: the display waveguide is currently intact, the display waveguide is currently damaged, the display waveguide currently has one or more fissures, or the display waveguide currently has a discontinuity.

Herein, the term “communicative” as in “communicative pathway,” “communicative coupling,” and in variants such as “communicatively connected” or “communicatively coupled,” is generally used to refer to any engineered arrangement for transferring or exchanging information. Examples of communicative pathways include, but are not limited to, electrically conductive pathways (e.g., electrically conductive wires, electrically conductive traces), wireless pathways, magnetic pathways (e.g., magnetic media), or optical pathways (e.g., optical fiber), and exemplary communicative couplings or communicative connections include, but are not limited to, electrical couplings, magnetic couplings, optical couplings, or wireless connections. Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” “to, at least, provide,” “to, at least, transmit,” and so on.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A head mounted display (HMD) device comprising:
a frame housing an image projector to project display light;
a display waveguide to receive the display light from the image projector; and
a detection controller to determine a current breakage status of the display waveguide.

2. The HMD device of claim 1, further comprising:
a conductive loop positioned at a perimeter of at least a portion of the display waveguide; and
one or more electrical contact pads in contact with the conductive loop and communicatively connected to the detection controller, wherein the detection controller monitors loop resistance of the conductive loop,
wherein the detection controller is further to determine the current breakage status of the display waveguide based on the monitored loop resistance of the conductive loop.

3. The HMD device of claim 2, wherein:
the frame houses the detection controller; and
the detection controller is further to detect the current breakage status of the display waveguide based on determining that the monitored loop resistance indicates that the conductive loop is currently not a short circuit.

4. The HMD device of claim 2, wherein the conductive loop is configured to operate as a radio frequency antenna.

5. The HMD device of claim 1, wherein the detection controller is further to initiate deactivation of the image projector in response to the current breakage status of the display waveguide indicating that the display waveguide is damaged.

6. The HMD device of claim 1, wherein the detection controller is communicatively connected to one or more strain gauges on one or more points of contact of an assembly of the display waveguide with the frame to detect a change in stress in the assembly.

7. The HMD device of claim 1, wherein the detection controller is communicatively connected to one or more photodiodes that monitor incoupled light at an edge of the display waveguide to detect changes to the incoupled light.

8. The HMD device of claim 1, wherein the detection controller is communicatively connected to one or more detectors that detect changes to amplitude of one or more surface acoustic waves (SAWs) coupled on the display waveguide.

9. A method comprising:
receiving, by a display waveguide, display light from a projector; and
determining a current breakage status of the display waveguide based on information generated by one or more sensors.

10. The method of claim 9, wherein:
the one or more sensors include one or more electrical contact pads in contact with a conductive loop positioned at a perimeter of at least a portion of the display waveguide, the electrical contact pads communicatively connected to a circuit that monitors loop resistance of the conductive loop; and
determining the current breakage status includes determining the current breakage status of the display waveguide based on the monitored loop resistance of the conductive loop.

11. The method of claim 10, wherein determining the current breakage status further includes determining the current breakage status of the display waveguide based on determining that the monitored loop resistance indicates that the conductive loop is currently not a short circuit.

12. The method of claim 10, wherein the conductive loop is configured to additionally operate as a radio frequency antenna.

13. The method of claim 9, further comprising:
initiating a deactivation of the projector in response to determining a breakage status of the display waveguide indicating that the display waveguide is damaged.

14. The method of claim 9, wherein the one or more sensors include at least one of:
one or more strain gauges disposed on one or more points of contact of an assembly of the display waveguide with a frame of a headset, wherein determining the current breakage status further includes detecting a change in stress in the assembly based on receiving strain gauge signals from the one or more strain gauges;
one or more photodiodes that monitor incoupled light at an edge of the display waveguide, wherein determining the current breakage status further includes detecting one or more changes to the incoupled light; or
one or more detectors that monitor surface acoustic waves (SAWs) coupled on the display waveguide, wherein determining the current breakage status further includes detecting changes to amplitude of one or more of the surface acoustic waves SAWs coupled on the display waveguide.

15. The method of claim 9, wherein the current breakage status of the display waveguide includes one or more of: the display waveguide being currently intact, the display waveguide being currently damaged, the display waveguide currently having one or more fissures, or the display waveguide currently having a discontinuity.

16. The HMD device of claim 2, wherein the detection controller is further to initiate deactivation of the image projector in response to the current breakage status of the display waveguide indicating that the display waveguide is damaged.

17. The HMD device of claim 16, wherein the detection controller is communicatively connected to one or more strain gauges on one or more points of contact of an assembly of the display waveguide with the frame to detect a change in stress in the assembly.

18. The HMD device of claim 16, wherein the detection controller is communicatively connected to one or more photodiodes that monitor incoupled light at an edge of the display waveguide to detect changes to the incoupled light.

19. The HMD device of claim 16, wherein the detection controller is communicatively connected to one or more detectors that detect changes to amplitude of one or more surface acoustic waves (SAWs) coupled on the display waveguide.

20. The HMD device of claim 16, wherein the conductive loop is configured to operate as a radio frequency antenna.
